(19) United States
(12) Patent Application Publication
(10) Pub. No.: US 2024/0176358 A1
(43) Pub. Date: May 30, 2024

(54) MOBILE ROBOT MANAGEMENT SYSTEMS

(71) Applicant: OMRON Corporation, Kyoto-shi (JP)

(72) Inventor: Karthick Phillip Nagarajan, Fremont, CA (US)

(21) Appl. No.: 18/504,974

(22) Filed: Nov. 8, 2023

Related U.S. Application Data
(60) Provisional application No. 63/385,193, filed on Nov. 28, 2022.

(51) Int. Cl. G05D 1/02

(52) U.S. Cl. CPC G05D 1/0291; G05D 1/0217; G05D 1/0272

(57) ABSTRACT

A mobile robot management system can receive path length values from a fleet of mobile robots that navigate an environment. The system can populate a database with the path length values. When assigning tasks to the robots, the system can use the task locations and the mobile robot locations to look up path length values in the database, and the system can use those path length values to select which mobile robot to select for the task.

### CROSS-REFERENCE TO RELATED APPLICATIONS

This application claims the priority benefit of U.S. Provisional Patent Application No. 63/385,193, filed Nov. 28, 2022, and titled “MOBILE ROBOT MANAGEMENT SYSTEMS”. The entirety contents of each of the above-identified application(s) are hereby incorporated by reference herein and made part of this specification for all that they disclose.

### BACKGROUND

### Field of the Disclosure

Some embodiments disclosed herein relate to systems for managing mobile robots, such as for assigning tasks to mobile robots.

### Description of the Related Art

Although mobile robot management systems are known for assigning tasks to mobile robots based on certain criteria, there remains a need for improved mobile robot management systems.

### SUMMARY

Certain example aspects of the present disclosure are summarized below for illustrative purposes. The disclosure is not limited to the specific implementations recited herein. Aspects of the disclosure may include several novel features, no single one of which is solely responsible for its desirable attributes.

Various aspects of the disclosure can relate to a mobile robot fleet management system, which can include a communication module configured to communicate with a fleet of mobile robots in an environment; a processor; and computer-readable memory in communication with the processor. The memory can be configured to store a database of path length information. The memory can store instructions that are executable by the processor to cause the system to receive path length information from the mobile robots as the mobile robots navigate the environment; store the path length information in the database; identify a task location; identify locations of a plurality of the mobile robots; obtain path length values from the database for paths from the plurality of mobile robots to the task location; and assign the task to one of the plurality of mobile robots based at least in part on the path length values.

The instructions can be configured to cause the system to receive location information from the mobile robots and to store the location information in the database. The instructions can be configured to cause the system to receive a path length value from a first robot location to the task location; and determine whether the database already has a prior value for the path length from the first robot location to the task location, and disregard the received path length value when the database already has the prior value. The instructions can be configured to cause the system to obtain path length values from the database for paths from a first group of the plurality of mobile robots to the task location; identify a second group of the plurality of mobile robots for which the database does not have path length values to the task location; and determine whether a number of robots in the first group satisfies a threshold. When the number of robots in the first group satisfies the threshold, the system can assign the task to a selected robot of the first group of the plurality of mobile robots, where the selected robot is selected based at least in part on the path length values. When the number of robots in the first group does not satisfy the threshold, the system can assign the task to a robot based at least in part on proximity of the robot to the task location.

The instructions can be configured to cause the system to receive an actual path length value from the assigned one of the mobile robots for an actual path for the assigned one of the mobile robots to the task location; comparing the actual path length value and an expected path length value from the database to determine whether the actual path length value and the expected path length value differ by more than a threshold amount; and modifying the database when the actual path length value and the expected path length value differ by more than the threshold amount. The instructions can be configured to cause the system to replace the expected path length value in the database with the actual path length value. The instructions can be configured to cause the system to clear a plurality of entries of the database for a zone that includes the location of the assigned one of the mobile robots. The instructions can be configured to cause the system to produce a new database of path length values.

The instructions can be configured to cause the system to send instructions to a mobile robot to perform path finding for a route that the mobile robot is not traveling, and to receive the path length information for the route from the mobile robot, and to store the path length information in the database.

Various aspects of the disclosure can relate to a mobile robot fleet management system, which can include a communication module configured to communicate with a fleet of mobile robots in an environment; a processor; and computer-readable memory in communication with the processor. The memory can be configured to store a database of path length information. The memory can store instructions that are executable by the processor to cause the system to identify a task location; identify locations of a plurality of the mobile robots; obtain path length values from the database for paths from a first group of the plurality of mobile robots to the task location; identify a second group of the plurality of mobile robots for which the database does not have path length values to the task location; and determine whether a number of robots in the first group satisfies a threshold. When the number of robots in the first group satisfies the threshold, the system can assign the task to a selected robot of the first group of the plurality of mobile robots, where the selected robot is selected based at least in part on the path length values. When the number of robots in the first group does not satisfy the threshold, the system can assign the task to a selected robot based at least in part on proximity of the robot to the task location.

The instructions can be configured to cause the system to receive path length information from the mobile robots as the mobile robots navigate the environment; and store the path length information in the database. The instructions can be configured to cause the system to receive location information from the mobile robots and to store the location information in the database. The instructions can be configured to cause the system to receive an actual path length value from the selected robot for an actual path for the assigned one of the mobile robots to the task location; compare the actual path length value and an expected path length value from the database to determine whether the actual path length value and the expected path length value differ by more than a threshold amount; and modify the database when the actual path length value and the expected path length value differ by more than the threshold amount. The instructions can be configured to cause the system to replace the expected path length value in the database with the actual path length value. The instructions can be configured to cause the system to clear a plurality of entries of the database for a zone that includes the location of the selected mobile robot. The instructions can be configured to cause the system to produce a new database of path length values. The instructions can be configured to cause the system to send instructions to a mobile robot to perform path finding for a route that the mobile robot is not traveling, and to receive the path length information for the route from the mobile robot, and to store the path length information in the database.

Various aspects of the disclosure can relate to a mobile robot fleet management system, which can include a communication module configured to communicate with a fleet of mobile robots in an environment; a processor; and computer-readable memory in communication with the processor. The memory can be configured to store a database of path length information. The memory can store instructions that are executable by the processor to cause the system to obtain an expected path length value from the database for a mobile robot to travel to a task location; receive an actual path length value from the mobile robot for an actual path for the mobile robot to travel to the task location; compare the actual path length value and the expected path length value to determine whether the actual path length value and the expected path length value differ by more than a threshold amount; and modify the database when the actual path length value and the expected path length value differ by more than the threshold amount.

The instructions can be configured to cause the system to replace the expected path length value in the database with the actual path length value. The instructions can be configured to cause the system to clear a plurality of entries of the database for a zone that includes the location of the mobile robot. The instructions can be configured to cause the system to produce a new database of path length values.

Various aspects of the disclosure can relate to a method for management of a mobile robot fleet, which can include receiving path length information from mobile robots as the mobile robots navigate the environment; storing the path length information (e.g., in a database); identifying a task location; identifying locations of a plurality of the mobile robots; obtaining path length values from the database for paths from the plurality of mobile robots to the task location; and assigning the task to one of the plurality of mobile robots based at least in part on the path length values. The method can include various other features as discussed above or elsewhere herein.

Various aspects of the disclosure can relate to a method for management of a mobile robot fleet, which can include identifying a task location; identifying locations of a plurality of the mobile robots; obtaining path length values from the database for paths from a first group of the plurality of mobile robots to the task location; identifying a second group of the plurality of mobile robots for which the database does not have path length values to the task location; and determining whether a number of robots in the first group satisfies a threshold. When the number of robots in the first group satisfies the threshold, the method can assign the task to a selected robot of the first group of the plurality of mobile robots, where the selected robot is selected based at least in part on the path length values. When the number of robots in the first group does not satisfy the threshold, the method can assign the task to a selected robot based at least in part on proximity of the robot to the task location. The method can include various other features as discussed above or elsewhere herein.

Various aspects of the disclosure can relate to a method for management of a mobile robot fleet, which can include obtaining an expected path length value from the database for a mobile robot to travel to a task location; receiving an actual path length value from the mobile robot for an actual path for the mobile robot to travel to the task location; comparing the actual path length value and the expected path length value to determine whether the actual path length value and the expected path length value differ by more than a threshold amount; and modifying the database when the actual path length value and the expected path length value differ by more than the threshold amount. The method can include various other features as discussed above or elsewhere herein.

The methods can be performed by a hardware processor executing instructions stored in computer-readable memory (e.g., on a non-transitory medium). The methods can be performed by an application-specific integrated circuit (ASIC), or on another type of special purpose processor that is configured to perform the method. The methods can be performed by a single processor or by a plurality of processors, which can coordinate to perform the method, for example.

### BRIEF DESCRIPTION OF THE DRAWINGS

Certain embodiments will be discussed in detail with reference to the following figures, wherein like reference numerals refer to similar features throughout. These figures are provided for illustrative purposes and the embodiments are not limited to the specific implementations illustrated in the figures.

FIG. 1 shows an example embodiment of a mobile robot.

FIG. 2 is a schematic diagram of an example embodiments of a mobile robot.

FIG. 3 is a schematic diagram of a mobile robot management system in communication with mobile robots and a user device.

FIG. 4 shows an example embodiment of a mobile robot fleet being controlled by a management system.

FIG. 5 shows an example embodiment of a mobile robot fleet being controlled by a management system.

FIG. 6 is a flowchart of an example method for assigning a task to a mobile robot.

FIG. 7 shows an example of managed environment divided in to a grid of areas.

FIG. 8 shows an example embodiment of a database with path length information.

FIG. 9 is a flowchart of an example method for assigning a task to a mobile robot.

FIG. 10 is a flowchart of an example method for determining a change in the environment.

FIG. 11 shows an example environment with two robots and two tasks.

### DETAILED DESCRIPTION OF CERTAIN EMBODIMENTS

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

A mobile robot management system can manage a fleet of mobile robots, such as by assigning tasks to the various robots. The robot management system can receive task requests from users (e.g., in response to pressing a call button or submitting a task via a user interface), or from another system. In some cases, the robot management system, or another system, can generate the individual tasks to be performed by the robots, such as based on project parameters or other information. The robot management systems can include various features disclosed in U.S. Pat. No. 10,089,586 (the '586 Patent), titled “JOB MANAGEMENT SYSTEM FOR A FLEET OF AUTONOMOUS MOBILE ROBOTS.” and issued on Oct. 2, 2018, the entirety of which is hereby incorporated by references for all that it discloses.

The robot management system can assign tasks to individual robots, such as using task assignment criteria, which can include the distance of the robot from the goal or location of the task, the status of the robot (e.g., idle or performing another task), how long the robot has been idle, a charge state of the robot (e.g., fully charged, amount of charge, and/or whether the robot has sufficient charge to perform the task), the priority level of the task, etc. In some robot management systems, the distance of the robot from the location of the task can be the Euclidean distance, or the distance of a direct path from the location of the robot to the location of the task (e.g., irrespective of obstacles, boundaries, or navigation rules). For example, in some cases, the management system can assign the task to the available robot that has the position that is closest to the goal or location of the task.

In some cases, the mobile robot is not able to navigate directly from its current location to the location of the task, such as due to obstacles, boundaries, or navigation rules (e.g., one-way zones). Accordingly, the closest robot may not be the robot with the shortest path distance to the location of the task. In some embodiments, the management system can assign tasks based at least in part on the lengths of the available paths from the robots to the task locations. In some systems, the individual robots can perform the path planning to navigate between locations in the environment, and the management system does not have direct access to the path planning functionality. In some cases, the management system can perform the path planning, but it can be time consuming to determine the path lengths for several robots for each task, which can delay assignment of the tasks. In some cases, the management system can instruct several available robots to perform path planning to determine the potential path distances from the robots to the task location and to report the determined path distances to the management system, so that the management system can assign the task based at least in part on the reported path distances. However, waiting for the robots to perform the pathfinding and report the path distances can delay the assigning of the tasks, and network connection issues or latency can further delay or impede the process of assigning tasks.

The management system can store a database of path distances between various locations in the environment. When the mobile robots perform path finding in the environment, they can send the path length information to the management system to populate the information in the database. As more pathfinding is performed by the fleet of robots, the database stored by the management system can become more thorough. When a new task needs to be assigned, the management system can look up the path lengths from the available robots to the task location in the database, and the management system can use the path lengths when assigning the task, such as by assigning the task to the available robot that has the shorted path length to the task location.

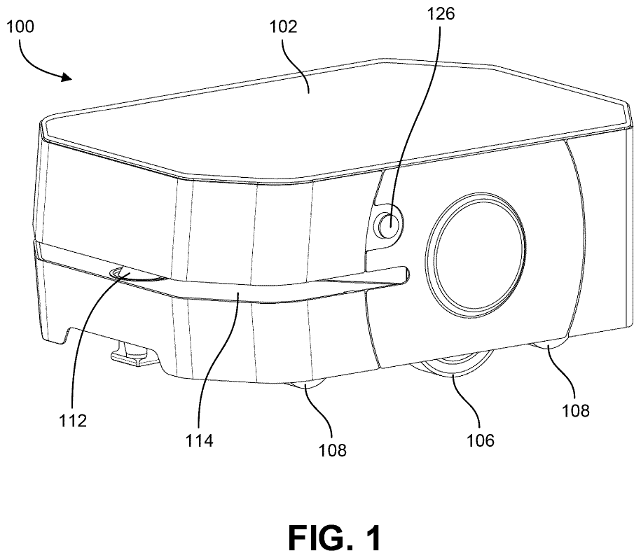

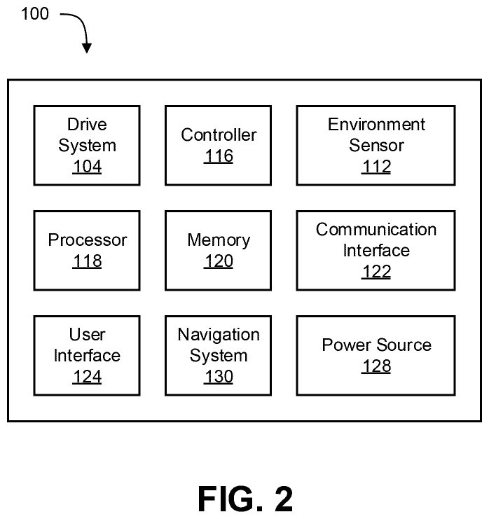

FIG. 1 shows an example embodiment of a mobile robot 100. FIG. 2 shows a schematic diagram of a mobile robot 100. The mobile robot 100 can have a chassis or housing 102, which can support various other components of the robot 100. Some components can be disposed inside the housing 102, and some components can be at least partially exposed so that they can interact with entities outside the housing 102. The robot 100 can have a drive system 104, which can be configured to move the robot 100. For example, the robot 100 can have one or more driven wheels 106, which can be driven by at least one motor (not visible in FIG. 1). In some embodiments, two or more driven wheels 106 can be independently driven to cause the mobile robot 100 to move forward, move backward, turn, etc. In some embodiments, a steering mechanism (e.g., a pivoting wheel) can turn the robot 100. In some cases, one or more non-driven wheels 108 can provide support to the robot 100. Various other suitable drive systems can be used, such as tracks or legs.

The robot 100 can have an environmental sensor 112, which can be used to sense or measure the environment around the robot 100. The environmental sensor 112 can be a Lidar system, for example. The environmental sensor 112 can include at least one laser, which can emit laser pulses across a range of angles. The environmental sensor 112 include a light detector, which can receive light from the laser pulses that was reflected by the environment (e.g., objects) around the robot 100. The received light can be used to determine the location over objects around the robot 100. For example, the direction of the emitted laser pulse and/or the direction of the received light can indicate the direction of the object, and the timing of the emitted laser pulse and/or the received light (e.g., time-of-flight) can indicate the distance of the object from the robot. The housing 102 of the robot 100 can have an opening 114, such as a generally horizontal slit, to permit light to exit and enter the environmental sensor 112 of the robot 100 (e.g., across a range of angles). Various other types of environmental sensors 112 could be used, such a camera, a video analysis system that analyzes video from a camera on the robot 100 to identify objects or other environmental features, a sonar system, and/or a heat sensor, etc.

The system can include a controller 116, which can operate various aspect of the robot 100. For example, the controller 116 can interpret information from the environmental sensor 112, such as to identify objects, determine distances to or locations of objects, operate the drive system 104, perform navigation and/or collision avoidance operations, communicate with the robot management system, or various other features and functions of the robot 100. The various functions of the robot 100 disclosed herein can be implemented by the controller 116, even where the controller 116 is not specifically discussed.

The robot 100 can include at least one processor 118, which can be a hardware processor. The processor 118 can include circuitry configured to execute operations to implement the various functions and features discussed herein. In some embodiments, the robot 100 can include multiple processors 118, and different tasks can be performed by different processors 118. The robot 100 can include memory 120, which can be computer-readable memory (e.g., non-transitory computer-readable memory). The memory 120 can include RAM, ROM, non-volatile memory, flash memory, a hard disc, or any other suitable type of memory. In some embodiments, the robot 100 can include multiple memory components, which can store different types of information or instructions for different function or features. The memory 120 can include instructions that can be executed by the at least one processor 118 to implement the controller 116 and/or to perform the various functions and features disclosed herein. In some embodiments, the functions and/or features can be implemented by an integrated circuit or other special purpose processor that is specifically configured to perform the functions and features disclosed herein. In some cases, the controller 116 can include a plurality of control modules. Different tasks or functions can be performed by different control modules (e.g., different processors 118 and/or different sets of software instructions).

The robot 100 can include a communication interface 122, which can be used to send information from the robot 100 and/or to receive information from the robot management system or some other external device. The communication interface 122 can be wireless, such as using WiFi, Bluetooth, or any other suitable wireless communication protocol. In some embodiments, the communication interface 122 can include a wired connection. For example, the communication interface 122 can include a port or a plug, which can be configured to connect to a corresponding plug or port that is coupled to an external device, to enable communication therebetween, in some situations. For example, a USB port can be used, although various types of ports or other wired connections could be used. In some cases, a user can couple a laptop, smartphone, or other computer device to the robot 100 via the communication interface for adjusting parameter of the robot 100, for diagnosing issues with the robot 100, for updating features of the robot 100, etc.

The robot 100 can include a user interface 124, which can be used to receive input from a user and/or to provide output (e.g., information) to a user. The user interface 124 can include one or more buttons 126, switches, dials, or other user input elements, a touchscreen, a display, one or more lights, a speaker, a microphone, etc. In some cases, a user can provide input to adjust parameter of the robot 100.

The robot 100 can include a power source 128, which can be a battery. The battery can be rechargeable, and the robot 100 can be configured to dock with a recharging station for regarding the battery (e.g., through an electrical interface). The power source 128 can provide electrical power to operate the drive system 104 (e.g., one or more electric motors), the various sensors and controllers and other systems disclosed herein. The power source 128 can provide DC or AC power, and any suitable type of power source 128 could be used.

The robot 100 can include a navigation system 130. The navigation system 130 can be used to perform path finding for the robot 100. The navigation system 130 can receive a destination and/or one or more waypoints, such as from the user interface 124 or the communication interface 122. The navigation system 130 can receive environmental information (e.g., object locations) from the environmental sensor 112, and can use that information to determine trajectory information to navigate the robot 100 (e.g., towards a destination). The trajectory information can include a path or route, such as from the robot's current location to the target location (e.g., task location or other destination or waypoint). In some cases, the navigation system 130 can determine intermediate waypoints based on the environmental information. In some embodiments, the navigation system 130 can modify the trajectory information while the robot 100 is moving. For example, if an object moves or a new object is detected (e.g., by the environment sensor 112), the navigation system 130 can determine to change the path or route of the robot 100.

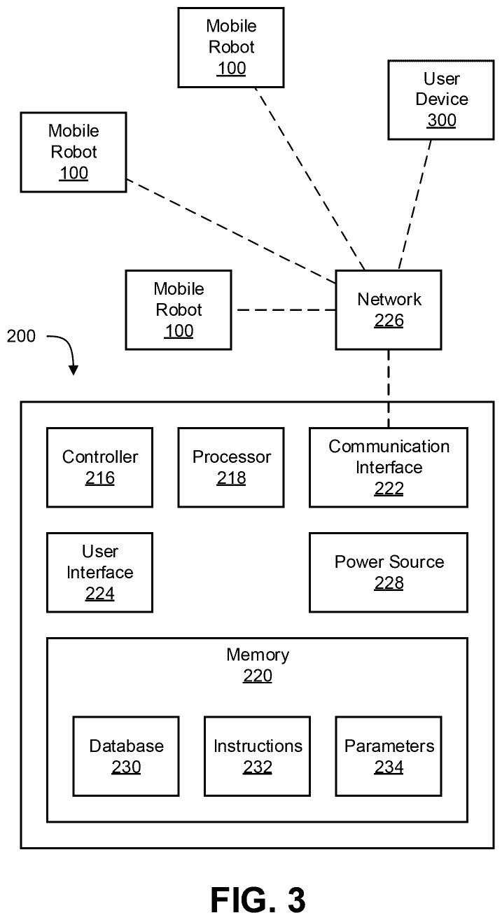

FIG. 3 shows a schematic diagram of a mobile robot management system 200, which can manage a fleet of mobile robots 100. In FIG. 3, three mobile robots 100 are shown, but any suitable number of robots 100 can be managed by the system 200, such as 2, 4, 8, 12, 20, 30, 40, 50 robots or more, or any values or ranges between these numbers. The robot management system 200 can manage robots in a factory, office, hospital, retail store, warehouse, or any other suitable facility, such as that has task to be performed by robots 100 at various locations. The robot management system 200 can include or user many of the features and/or functions disclosed in the '586 Patent. The robot management system 200 can include a controller 216, which can operate various aspect of the robot management system 200, as described herein. For example, the controller 216 can manage task, such as by receiving, generating, and/or assigning tasks. The controller 216 can manage the database 230, as discussed herein. The various functions of the robot management system 200 disclosed herein can be implemented by the controller 216, even where the controller 216 is not specifically discussed.

The robot management system 200 can include at least one processor 218, which can be a hardware processor. The processor 218 can include circuitry configured to execute operations to implement the various functions and features discussed herein. In some embodiments, the robot management system 200 can include multiple processors 218, and different tasks can be performed by different processors 218. The robot management system 200 can include memory 220, which can be computer-readable memory (e.g., non-transitory computer-readable memory). The memory 220 can include RAM, ROM, non-volatile memory, flash memory, a hard disc, or any other suitable type of memory. In some embodiments, the robot management system 200 can include multiple memory components, which can store different types of information or instructions for different function or features. The memory 220 can include instructions that can be executed by the at least one processor 218 to implement the controller 216 and/or to perform the various functions and features of the management system 200. In some embodiments, the functions and/or features of the robot management system 200 can be implemented by an integrated circuit or other special purpose processor that is specifically configured to perform the functions and features disclosed herein. In some cases, the controller 216 can include a plurality of control modules. Different tasks or functions can be performed by different control modules (e.g., different processors 218 and/or different sets of software instructions).

The robot management system 200 can include a communication interface 222, which can be used to send information from the robot management system 200 to the robots 100 and/or to other systems or devices. The communication interface 222 can receive information from the robots 100 and/or other systems or devices. The communication interface 222 can be a wireless communication interface, such as using WiFi, Bluetooth, or any other suitable wireless communication protocol. In some embodiments, the communication interface 222 can include a wired connection. For example, the communication interface 222 can include a port or a plug, which can be configured to connect to a corresponding plug or port that is coupled to an external device, to enable communication therebetween, in some situations. For example, a USB port can be used, although various types of ports or other wired connections could be used. In some cases, a user can couple a laptop, smartphone, or other computer device to the robot management system 200 via the communication interface for adjusting parameter 234 of the robot management system 200, for diagnosing or troubleshooting issues, for updating features of the robot management system 200, etc. The robot management system 200 can communicate with the robots 100 and/or other systems or devices over a network 226, which can be a wireless network, such as a WiFi network. The network 226 can be a shared network that communicates other types of information as well as information relating to management of the fleet of robots 100. In some embodiments, the network 226 can be a dedicated network, which can be used exclusively for operating the fleet of robots.

The robot management system 200 can communicate with an external system or device, such as a user device 300, over the network 226, or in any other suitable manner. The user device 300 can be a user terminal or other computing device at a work station or other location in the facility that uses the fleet of robots. For example, the user device 300 can be at a computer at a factory workstation, at an office workstation, a nurse workstation, a patient room, a point of sale station, a manager desk or office, etc. The user device 300 can be mobile user device, such as a smartphone, a tablet computer, etc. The user device 300 can send tasks to the robot management system 200 to be assigned to the robots 100. In some cases, multiple user devices 300 can be used. One or more of the user devices 300 can be located at the environment with the mobile robots 100, or can be remote to the environment with the mobile robots 100 (e.g., communicating over the internet or some other wide area network).

The robot management system 200 can include a user interface 224, which can be used to receive input from a user and/or to provide output (e.g., information) to a user. The user interface 224 can include one or more buttons, switches, dials, or other user input elements, a keyboard, a touchscreen, a display, one or more lights, a speaker, a microphone, etc. In some cases, a user can provide input to adjust parameter of the robot management system 200 via the user interface 224, or via the user device 300.

The robot management system 200 can include a power source 228, which can be a wired power connection (e.g., such as configured to plug into an outlet). In some cases a battery (e.g., rechargeable) can be used. The power source 228 can provide electrical power to operate the robot management system 200 as disclosed herein. The power source 228 can provide DC or AC power, and any suitable type of power source 228 could be used.

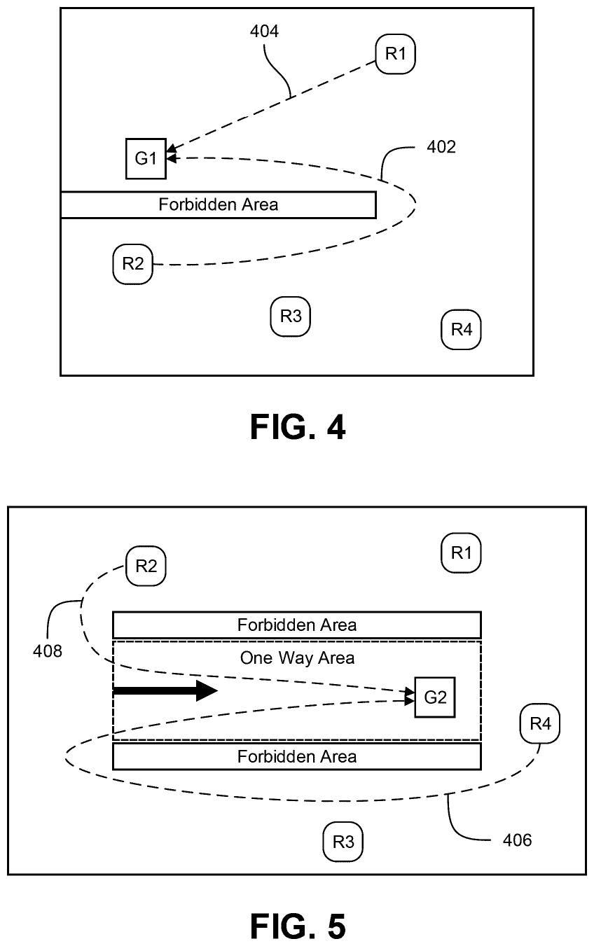

FIG. 4 shows an example in which a portion of an environment includes four robots: R1, R2, R3, and R4. The environment includes a forbidden area, which can be a wall, a ditch, an object, or some other boundary that the robots are not permitted to pass through or enter. A task can have a goal or location at G1. If the robot management system 200 were to assign the task to the available robot that is closes to the G1 location, then the task would be assigned to the robot R2. However, the robot R2 is not able to navigate directly to the location G1 because of the forbidden area. Instead, the robot R2 would need to follow path 402 around the forbidden area before moving back along the other side of the forbidden area to reach the location G1. In this situation, the actual path length from robot R2 to the task location G1 is several times longer than the initial distance between the robot R2 and the task location G1. Instead of using the Euclidean distances, the robot management system 200 can compare the actual path lengths from the locations of the available robots R1. R2, R3, and R4 to the task location G1, which information can be stored in the memory 220, such as in the database 230. The robot management system 200 can instead assign the task to robot R1, which can move to the task location G1 along path 404 that has the shortest path length to the task location G1 (e.g., even though the R2 and R3 robots are closer in Euclidean distance).

FIG. 5 shows an example that includes a one way area. The portion in FIG. 5 includes four robots: R1, R2, R3, and R4. A one way area is bounded on two opposing sides by forbidden areas, so that the one way area has an entrance (e.g., on the left side of FIG. 5) and an exit (e.g., on the right side of FIG. 5). A task can have a goal or location at G2. If the robot management system 200 were to assign the task to the available robot that is closes to the G2 location, then the task would be assigned to the robot R4. However, the robot R4 is not able to navigate directly to the location G2 because of the one way area. The robot R4 is not permitted to enter the one way area through the exit side. Rather, the robot R4 would need to follow path 406 around to the entrance to the one way area before navigating down the one way area to the task location G2. In this situation, the actual path length from robot R4 to the task location G2 is significantly longer than the initial distance between the robot R4 and the task location G2. The robot management system 200 can compare the actual path lengths from the locations of the available robots R1, R2, R3, and R4 to the task location G2, which information can be stored in the memory 220, such as in the database 230. The robot management system 200 can assign the task in FIG. 5 to robot R2, which can be position generally near the entrance to the one-way area in the example of FIG. 5.

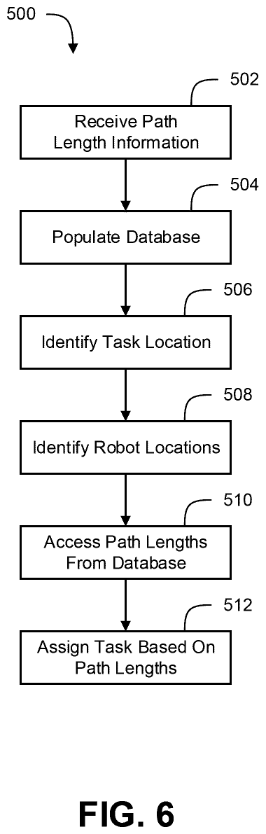

FIG. 6 is a flowchart of an example method 500 for assigning a task to a robot. The method 500 can be performed by the mobile robot management system 200. At block 502, the system 200 can receive path length information from the robots 100. As the robots 100 navigate around the environment, they can send the path lengths to the robot management system 200. The path lengths can be determined by the robots 100 using the navigation systems 130 on the individual robots 100, such as when traveling to locations for tasks assigned by the management system, and/or when traveling to other locations such as to a recharging dock, to a repair station, etc. The path length information can include the start location, end location, and the path length. At block 504, the system 200 can populate the database with the path length information. As the robots 100 perform more and more pathfinding in the environment, the database can have more and more path length information, and the system 200 can get better and better at selecting the robots with the shortest path lengths to the task locations.

At block 506, the system 200 can identify a task location. The system 200 can receive the task from an external system or device, or the system 200 can determine the task or location based on other information (e.g., project information). At block 508, the system 200 can identify robot locations. In some cases, the system 200 can identify only available robots that could be assigned the task (e.g., not already busy performing another task). The system could get location information for some busy robots as well, or for all robots, and in some cases the system can interrupt a task or reassign a robot to another task (e.g., based on task priority or robot specialty). In some cases, the system 200 can query the robots to determine their current locations at block 508. In some cases, the system 200 can store the current robot locations (e.g., in the memory 220, such as in the database 230). When a robot moves to a new location, it can send an update to the management system 200 to inform the management system of the robot's new location. In some cases, the robot can send periodic updates of its location to the system 200 as the robot moves between locations. Thus, the system would be able to evaluate whether to interrupt the current path of travel with an assignment of a new task. In some embodiments, the system 200 can identify the robot locations 508 without real-time communication with the robot, for example because the location information can be sent previously.

At block 510, the system 200 can access the database and obtain the path lengths from the robot locations to the task location. In some cases, the system 200 can compare each available robot location to the start locations in the path length info in the database, and the system 200 can use the closest start location (e.g., within a threshold distance). The system 200 can compare the task location to the end locations of the path length info in the database, and the system 200 can use the closest end location (e.g., within a threshold distance). The threshold(s) can be parameters 234, which can be stored in memory 220, and in some cases can be user adjustable (e.g., using the user interface 224). By way of example, the database might not have a path length value stored for a path from the exact location of a robot to the exact location of the task being assigned, but the database may have a path length stored in the database for a path that started 0.2 meters from the robot's current location, and that ended 0.1 meters from the location of the current task. If the thresholds were both set to 0.25 meters, then the system would use the path length from the database in the analysis for assigning the task. In some implementations, the task locations can be predefined, so that the task locations are accurate and no task location threshold distance is used.

At block 512, the system 200 can assign the task to one of the robots based at least in part on the path lengths from the robot locations to the task location. For example, the system 200 can assign the task to the available robot with the shortest path length to the task location. In some cases, other criteria can be used as well, such as charge status or charge level, current robot status, time that the robot has been idle, history of prior tasks and/or idle times, robot maintenance history, robot suitability for the task, etc. In some cases the system can determine a score value for each robot for a given task, and the task can be assigned to the robot with the highest score value, by way of example. In this example, a shorter path length distance to the task location can drive the score value up, but other criteria could reduce the score value (e.g., low charge level, etc.). Thus, in some cases, the system could assign the task to a robot that does not have the shortest path length to the task location. For example, if a second robot has a slightly longer path length to the task location than a first robot, the task might still be assigned to the second robot if the second robot has a battery that is more charged, or if the first robot had performed significantly more tasks than the second robot in a recent time period, or if the second robot has a higher weight carrying capacity, etc.

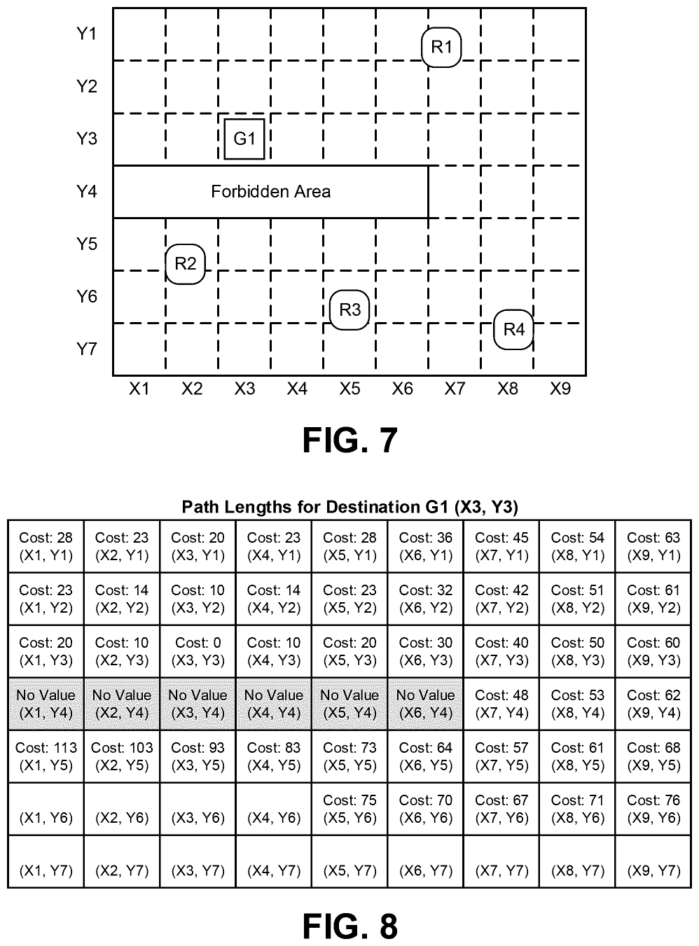

FIG. 7 shows an example with an environment that is divided into sections, such as using a grid. The area in FIG. 7 can have 9 areas along a first dimension (e.g., shown as an X-axis) and 7 areas along a second dimension (e.g., shown as the Y-axis), but any suitable size of area and any suitable number of areas and grid size can be used. The grid size and/or number of areas can be parameters 234, which can be stored in memory 220, and in some cases can be user adjustable (e.g., using the user interface 224). In the example of FIG. 7, the goal or task location G1 is located at (X3, Y3). The four robots can have positions on the grid with robot R1 at (X7, Y1), robot R2 at (X2, Y5), robot R3 at (X5, Y6), and robot R4 at (X8, Y7). The robots might not be centered in the respective areas. In some cases the location of the center of the robot, or some other designated location on the robot, can be used to determine which area use for the robot location. The system can treat a robot the same no matter where within the grid cell it is located, in some cases.

FIG. 8 shows an excerpt of the database for path lengths from various locations to the destination of (X3, Y3). The database can have similar information for various other destinations as well. In some embodiments, the database 230 can include a 3-dimensional array, although any suitable data structure could be used, such as one or more lookup tables, one or more lists (e.g., an unordered list), one or more arrays, etc. The location (X3, Y3) can have a path cost of 0, since that is the destination location. Some locations, e.g., (X1-X6, Y4), can have no value because those locations are in the forbidden area. The system 200 can be configured to consider the database complete or full even without values for the path length or path cost at the locations that are inside the forbidden area.

Many of the grid locations have a path cost or length that is stored or otherwise associated with the grid location, as shown in FIG. 8. However, in this example, the cells at (X1-X4, Y6) and (X1-X9, Y7) do not have path length/cost values. This could be because the robots have not yet performed pathfinding navigation from those location to the (X3, Y3) destination. Once one of the robots performs pathfinding from one of those locations to the (X3, Y3) destination, the database can be updated to include that information. For example, robot R4 is at (X8, Y7), which does not yet have a path length value for the destination (X3, Y3). If the robot R4 were to perform a navigation operation to find a path from (X8, Y7) to (X3, Y3), then that value could be added to the database. If the robot R4 were to determine a path distance of 80 units for example, then the robot R4 can send that value (e.g., and the starting and ending points) to the system 200, which can update the database by adding Cost: 80 to the cell (X8, Y7) in FIG. 8.

The robots can be configured to send the path length information to the system 200 whenever path finding is performed. The system 200 can be configured to disregard duplicate information. For example, when the system 200 receive pathfinding information between two locations, the system 200 can check whether the database already has path length information for the path between those two locations. If the database already has data for that path length, then the new value can be ignored, or in some cases the old value can be overwritten by the new value. For example, the system can determine if the new start location is within a threshold distance of the start location for a path length that is currently in the database for the same task location (or for a task location within a threshold distance of the end location of the path in the database). If the location(s) are within the threshold(s), the system 200 can disregard the new path length information. In some cases the new value can be compared to the prior value. If the numbers are within a threshold amount of each other, the system can keep one value or the other (or an average or other combination of the two). If the numbers differ by more than the threshold amount, the system can flag that as an indication that something in the environment has changed, which can be address as discussed herein. The threshold amount for comparing the values can be a parameter 234, which can be stored in memory 220, and in some cases can be user adjustable (e.g., using the user interface 224).

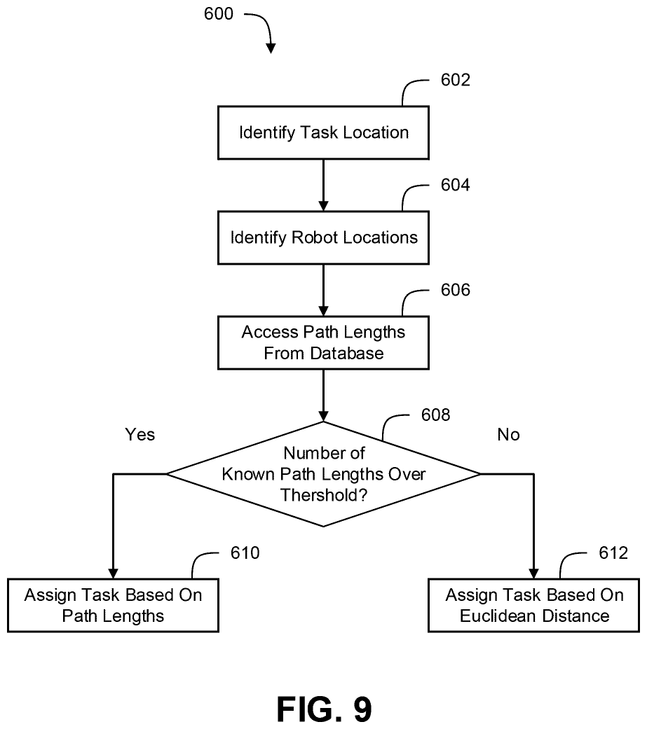

When the database is not sufficiently populated with path length information, the system can use the Euclidean distances for making task assignments. FIG. 9 show a flowchart of an example method 600 for assigning a task to a robot. The method 600 can be similar to the method 500 of FIG. 6, except as discussed herein. At block 602 the task location is identified. With reference to the example of FIGS. 7 and 8, the task location can be (X3, Y3). At block 604, the locations of the robots can be identified. At block the path lengths from the locations of the robots to the task location can be determined (e.g., from the database). For some robots (e.g., robot R4) the database may not have the path length value, while for other robots (e.g., robots R1, R2, and R3) the database does have the path length values. At block 608, the system 200 can evaluate the number or percentage of available robots have a known path length to the task location, for example as compared to the number or percentage of available robots for which the path length to the task location is not known.

If the number or percentage of robots with known path lengths is above a threshold, then method can proceed to block 610, and the system can assign the task based at least in part on the path lengths. At block 610, the system can disqualify the robot(s) (e.g., robot R4) for which no path length value is known. In some cases, the system 200 can task the robot(s) (e.g., robot R4) at location(s) where no path length to the task location is known to perform a navigation operation to determine the path length(s) from those robot(s) to the task location. Thus, the database can be built out and would be more complete for later tasks. If the number or percentage of robots with known path lengths is below the threshold, then method can proceed to block 612, and the system can assign the task based at least in part on the Euclidean distances (e.g., direct proximity value). At block 612, the path length values from the database can be ignored. The threshold amount at block 608 can be a parameter 234, which can be stored in memory 220, and in some cases can be user adjustable (e.g., using the user interface 224). With reference to the example of FIGS. 7 and 8, if the threshold value were set to 60%. The system 200 would proceed to block 610 because 75% of the available robots have a known path length to the task location at (X3, Y3).

In some embodiments, the system 200 can task idle robots with performing navigation operations for paths that do not yet have path length values in the database 630. For example, in the example of FIGS. 7 and 8, the system 200 can assign the task to robot R1. The system can task one or more of the other available robots R2, R3, and R4 with performing navigation operations from the (X1-X4, Y6) and (X1-X9, Y7) locations to the task location at (X3, Y3). The system can task the idle mobile robots to perform path finding from locations other than the location of the mobile robot. In some cases, the system can instruct the idle mobile robots to perform path finding from the current location of the mobile robot. The mobile robot can perform path finding to build out the database while the mobile robot is charging or while performing another task (e.g., if the task leaves surplus power that can be used for path finding operations). When a robot 100 is idle, it can send a notification to the management system 200 that it is available for supplemental path finding. The system 200 can respond by providing a start location and an end location for which the database 230 does not currently have a path length value. The robot 100 can then perform the navigation operation and determine the path length, and can report the path length to the management system 200, which can update the database 230 with the additional path length information. This process can repeat while the robot is idle.

In some embodiments, a mobile robot can send path length information to the system 200 for intermediate locations along the path between the robot starting location and the task location. This features can enable the database to be built out more quickly. In some cases, initial values can be permitted to be intermediate locations along a pathway, but when a robot performs a dedicated navigation operation for that starting location that new value and override the initial value. This can enable the database to get up and running quickly, while also enabling the database to mature as additional pathfinding is performed.

In some embodiments, the mobile robot management system 200 can manage multiple sub-fleets of robots. For example, an environment can be divided into sub-areas. A first sub-fleet of robots can operate in a first sub-area, and a second sub-fleet of robots can operate in a second sub-area, etc. The system 200 assigns robots for one sub-area to have tasks only for that one sub-area, while robots from another sub-area area assigned tasks only for that other sub-area.

In some embodiments, a change to the environment can change the path lengths between locations. For example, if a new desk or a pile of boxes is positioned to block an avenue that was previously open, than can change the path lengths for paths that used that avenue. In some embodiments, the system 200 can identify when something in the environment has changed. In some embodiments, the system 200 can modify the database in response to a change in the environment.

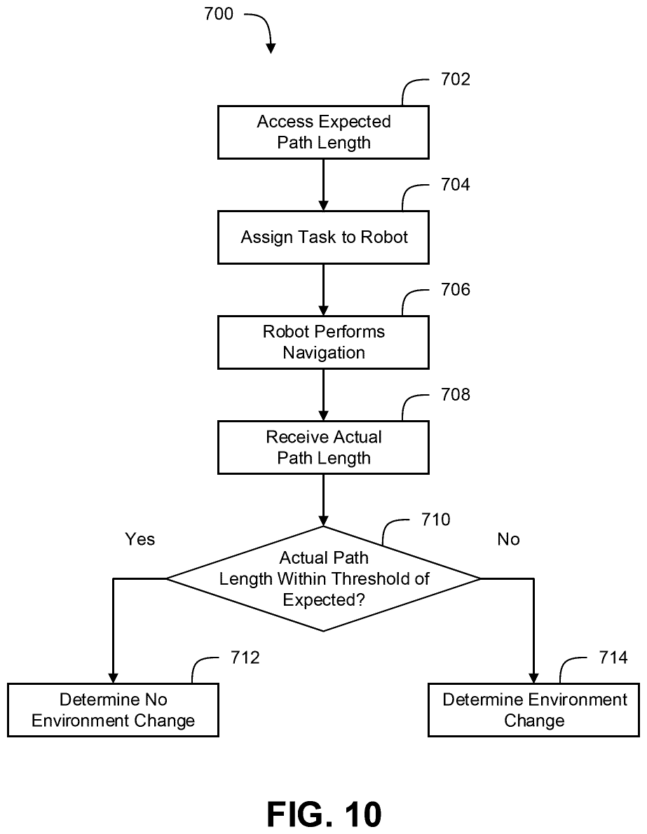

FIG. 10 shows a flowchart for example embodiment of a method 700 for determining that the environment has changed. The method 700 can include steps similar to the other methods disclosed herein, except as described. At block 702, the system 200 can access the expected path length, such as from the database 230. At block 704, the system 200 can assign the task to a robot, such as based at least in part on the expected path length (e.g., obtained from the database 230). Various methods for assigning the task to a robot, as disclosed herein, can be used for blocks 702 and 704.

At block 706, the robot can perform a navigation operation to find a path from the robot's current location to the task location. That actual path length that the robot will use to travel to the task location can be sent to the system, and can be received by the system 200 at block 708. At bock 710, the expected path length (e.g., from the database) can be compared to the actual path length (e.g., from the robot's navigation operation), and if they are within a threshold amount of each other, the method can proceed to block 712, which can be a determination that the environment has not changed in a way that would affect the robot's path length. However, if the actual path length (e.g., from the robot's navigation operation) differs from the expected path length (e.g., from the database) by more than a threshold amount, then the method can proceed to block 714, which can be a determination that the environment has changed to effect the path length from the robot to the task location. In some embodiments, the system 200 can be notified of a change to the environment by user input, or by another system or device.

The system 200 can respond to the change in the environment in various ways. In some embodiments, the system 200 can reassign the task, or can reevaluate the assignment of the task that was assigned at block 704, when a change is determined at 712. In some embodiments, the system 200 can keep the task assigned to the robot that had been assigned at block 706. In some embodiments, the system can keep the task with the originally assigned robot, if the difference between the expected and actual path lengths is below another threshold, while the system can reevaluate the task assignment if the difference is above that threshold. The threshold can be a parameter 234, which can be stored in memory 220, and in some cases can be user adjustable (e.g., using the user interface 224).

In some embodiments, the system can replace the database value to be the new path length that was determined by the robot at block 706. Accordingly, the system 200 can be configured to update the database on-the-fly as the robots perform navigation operations. If the environment has changed to alter the path length from one start location to one end location, then that same change would likely alter the path lengths for other similar paths. The system 200 can be configured to clear the database values for a zone around the starting location and/or for a zone around the ending location, in response to the determination that the environment changed. The system can then rebuild those parts of the database, as discussed herein. The size and/or shape of the zones can be parameters 234, which can be stored in memory 220, and in some cases can be user adjustable (e.g., using the user interface 224). In some cases it can be difficult to determine which portions of the database would be effected by a change in the environment. In some embodiments, a change in the environment can trigger the system 200 to clear the full database and start over. In some cases, the system can continue using the existing database, while it also prepares new database that accounts for the changed environment. Once the new database has reached a threshold level of completion, the system can transition from the prior database to the new database. This can enable the system to update the database, while reducing disruption while the new database is being prepared. The threshold can be a parameter 234, which can be stored in memory 220, and in some cases can be user adjustable (e.g., using the user interface 224).

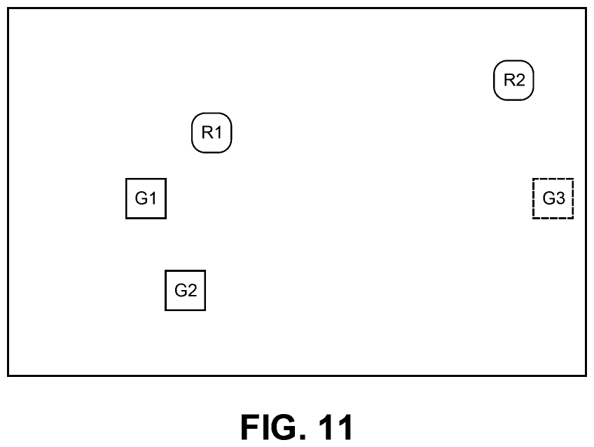

In some embodiments, the memory can store information about the times associated with completing the tasks. The system 200 can also store information about the speeds or travel times for the robots for various distances. The system 200 can use that information to string together multiple tasks assigned to one robot 100. FIG. 11 shows an example environment with two robots (R1 and R2) and two tasks (G1 and G2). Since the path length from R1 to G1 is shorter than the path length from R2 to G1, the system 200 can assign the task G1 to robot R1. In some cases, since R1 is now busy the second task G2 can be assigned to robot R2. However, in some implementations, if the time that it would take R2 to reach G2 is longer than the time it would take for R1 to move to G1, perform the first task, and then move to G2, then the system can assign the task to R1 instead of R2.

In some cases, tasks can be assigned or performed in a different order from which they were received or generated. With the Example of FIG. 11 where robot R1 is assigned to perform task G1 and then task G2, if another task G3 (shown in dashed lines) were received or generated at a location close to robot R2, then the system 200 can assign task G3 to robot R2 right away. Robot R2 can perform the third job G3 before robot R1 performs the second job R2, in this example. In some cases, the system 200 can wait to assign the second task G2, while the third task is assigned to robot R2 before the second task G2 gets assigned.

### Additional Information

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking. I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

Unless the context clearly requires otherwise, throughout the description and the claims, the words “comprise.” “comprising.” “include.” “including.” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above.” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

The following is claimed:

1. A mobile robot fleet management system comprising:
a communication module configured to communicate with a fleet of mobile robots in an environment;
a processor; and
computer-readable memory in communication with the processor, the memory configured to store a database of path length information; the memory storing instructions that are executable by the processor to cause the system to:
receive path length information from the mobile robots as the mobile robots navigate the environment;
store the path length information in the database;
identify a task location;
identify locations of a plurality of the mobile robots;
obtain path length values from the database for paths from the plurality of mobile robots to the task location; and
assign the task to one of the plurality of mobile robots based at least in part on the path length values.

2. The mobile robot fleet management system of claim 1, wherein the instructions are configured to cause the system to receive location information from the mobile robots and to store the location information in the database.

3. The mobile robot fleet management system of claim 1, wherein the instructions are configured to cause the system to:
receive a path length value from a first robot location to the task location; and
determine whether the database already has a prior value for the path length from the first robot location to the task location, and disregard the received path length value when the database already has the prior value.

4. The mobile robot fleet management system of claim 1, wherein the instructions are configured to cause the system to:
obtain path length values from the database for paths from a first group of the plurality of mobile robots to the task location;
identify a second group of the plurality of mobile robots for which the database does not have path length values to the task location;
determine whether a number of robots in the first group satisfies a threshold;
when the number of robots in the first group satisfies the threshold, assign the task to a selected robot of the first group of the plurality of mobile robots, where the selected robot is selected based at least in part on the path length values; and
when the number of robots in the first group does not satisfy the threshold, assign the task to a robot based at least in part on proximity of the robot to the task location.

5. The mobile robot fleet management system of claim 1, wherein the instructions are configured to cause the system to:
receive an actual path length value from the assigned one of the mobile robots for an actual path for the assigned one of the mobile robots to the task location;
comparing the actual path length value and an expected path length value from the database to determine whether the actual path length value and the expected path length value differ by more than a threshold amount; and
modifying the database when the actual path length value and the expected path length value differ by more than the threshold amount.

6. The mobile robot fleet management system of claim 5, wherein the instructions are configured to cause the system to replace the expected path length value in the database with the actual path length value.

7. The mobile robot fleet management system of claim 5, wherein the instructions are configured to cause the system to clear a plurality of entries of the database for a zone that includes the location of the assigned one of the mobile robots.

8. The mobile robot fleet management system of claim 5, wherein the instructions are configured to cause the system to produce a new database of path length values.

9. The mobile robot fleet management system of claim 1, wherein the instructions are configured to cause the system to send instructions to a mobile robot to perform path finding for a route that the mobile robot is not traveling, and to receive the path length information for the route from the mobile robot, and to store the path length information in the database.

10. A mobile robot fleet management system comprising:
a communication module configured to communicate with a fleet of mobile robots in an environment;
a processor; and
computer-readable memory in communication with the processor, the memory configured to store a database of path length information; the memory storing instructions that are executable by the processor to cause the system to:
identify a task location;
identify locations of a plurality of the mobile robots;
obtain path length values from the database for paths from a first group of the plurality of mobile robots to the task location;
identify a second group of the plurality of mobile robots for which the database does not have path length values to the task location;
determine whether a number of robots in the first group satisfies a threshold;
when the number of robots in the first group satisfies the threshold, assign the task to a selected robot of the first group of the plurality of mobile robots, where the selected robot is selected based at least in part on the path length values; and
when the number of robots in the first group does not satisfy the threshold, assign the task to a selected robot based at least in part on proximity of the robot to the task location.

11. The mobile robot fleet management system of claim 10, wherein the instructions are configured to cause the system to:
receive path length information from the mobile robots as the mobile robots navigate the environment; and
store the path length information in the database.

12. The mobile robot fleet management system of claim 10, wherein the instructions are configured to cause the system to receive location information from the mobile robots and to store the location information in the database.

13. The mobile robot fleet management system of claim 10, wherein the instructions are configured to cause the system to:
receive an actual path length value from the selected robot for an actual path for the assigned one of the mobile robots to the task location;
compare the actual path length value and an expected path length value from the database to determine whether the actual path length value and the expected path length value differ by more than a threshold amount; and
modify the database when the actual path length value and the expected path length value differ by more than the threshold amount.

14. The mobile robot fleet management system of claim 13, wherein the instructions are configured to cause the system to replace the expected path length value in the database with the actual path length value.

15. The mobile robot fleet management system of claim 13, wherein the instructions are configured to cause the system to clear a plurality of entries of the database for a zone that includes the location of the selected mobile robot.

16. The mobile robot fleet management system of claim 13, wherein the instructions are configured to cause the system to produce a new database of path length values.

17. The mobile robot fleet management system of claim 10, wherein the instructions are configured to cause the system to send instructions to a mobile robot to perform path finding for a route that the mobile robot is not traveling, and to receive the path length information for the route from the mobile robot, and to store the path length information in the database.

18. A mobile robot fleet management system comprising:
a communication module configured to communicate with a fleet of mobile robots in an environment;
a processor; and
computer-readable memory in communication with the processor, the memory configured to store a database of path length information; the memory storing instructions that are executable by the processor to cause the system to:
obtain an expected path length value from the database for a mobile robot to travel to a task location;
receive an actual path length value from the mobile robot for an actual path for the mobile robot to travel to the task location;
compare the actual path length value and the expected path length value to determine whether the actual path length value and the expected path length value differ by more than a threshold amount; and
modify the database when the actual path length value and the expected path length value differ by more than the threshold amount.

19. The mobile robot fleet management system of claim 18, wherein the instructions are configured to cause the system to replace the expected path length value in the database with the actual path length value.

20. The mobile robot fleet management system of claim 18, wherein the instructions are configured to cause the system to clear a plurality of entries of the database for a zone that includes the location of the mobile robot.

21. The mobile robot fleet management system of claim 18, wherein the instructions are configured to cause the system to produce a new database of path length values.
